(19) United States
(12) Patent Application Publication
(10) Pub. No.: US 2010/0042658 A1
(43) Pub. Date: Feb. 18, 2010

(54) METHOD FOR CAD KNOWLEDGE MANAGEMENT

(75) Inventors: Daisuke Kamiyama, Kanagawa-Ken (JP); Kouei Oishi, Hyogo-ken (JP); Tadashi Gotoh, Saitama-Ken (JP)

Correspondence Address: Locke Lord Bissell & Liddell LLP;Attn: IP Docketing, Three World Financial Center, New York, NY, 10281-2101, US

(73) Assignee: IBM Corporation, Armonk, NY (US)

(21) Appl. No.: 12/190,839

(22) Filed: Aug. 13, 2008

(51) Int. Cl. G06F 17/30

(52) U.S. Cl. 707/201; 707/E17.007

(57) ABSTRACT

A knowledge model of CAD knowledge may be created using a modeling language such as SysML to improve maintainability and re-usability of knowledge, thereby reducing workload. The SysML knowledge model may be stored in a knowledge repository coupled to a knowledge server. The SysML knowledge model may be accessed through the knowledge server. The SysML knowledge model may be associated with elements of a CAD model, and one or more elements of the CAD model may be linked to one or more corresponding elements in the knowledge model. Thus, when a value of one or more elements is changed in the knowledge model, the results of the change are updated substantially immediately in both the CAD model and the knowledge model and other applications using the knowledge model.

### FIELD OF THE INVENTION

The present invention generally relates to modeling and, more specifically, to modeling CAD knowledge.

### BACKGROUND

Computer-aided design (CAD) has been used to aid in the design and especially the drafting of a part or product. It is both a visual (or drawing) and symbol-based method of communication whose conventions are particular to a specific technical field. Drafting can be done in two dimensions (“2D”) and three dimensions (“3D”).

CAD is mainly used for detailed engineering of 3D models and/or 2D drawings of physical components, but it is also used throughout the engineering process from conceptual design and layout of products, through strength and dynamic analysis of assemblies to definition of manufacturing methods of components.

CAD enables designers to store various design know-how and verification standards in a CAD model and share the model with engineers by making it a template. However, workload is significantly increased when knowledge is changed (e.g., based on new discoveries). This makes it necessary to change not only the template but also all CAD models based on the template.

Additionally, there currently does not exist a system which makes knowledge, which originated from a CAD model, available to other CAD systems and applications.

### SUMMARY

The present system and method provide for modeling CAD knowledge using a modeling language (e.g., SysML) to improve maintainability and re-usability of knowledge, thereby reducing workload. The knowledge model may be stored in a knowledge repository coupled to a knowledge server. The knowledge model is accessed through the knowledge server. The knowledge model may be associated with elements of a CAD model and one or more elements of the CAD model may be linked to one or more corresponding elements in the knowledge model. Thus, when a value of one or more elements is changed in the knowledge model, the results of the change are updated substantially immediately in both the CAD model and the knowledge model.

According to an exemplary embodiment, the previously described problems may be solved by a method for managing CAD knowledge, comprising: creating a model of CAD knowledge using a modeling language; storing the knowledge model in a knowledge repository; providing access to the knowledge model through a knowledge server; associating the knowledge model with elements of a CAD model by adding association information to the elements; linking, as a verification object, one or more elements in the CAD model with one or more corresponding elements in the knowledge model; and updating substantially immediately, a change in value of the one or more elements in the knowledge model in both the CAD model and in the knowledge model.

### BRIEF DESCRIPTION OF THE DRAWINGS

The disclosure will be further understood from the following detailed description of one or more embodiments, taken in conjunction with appended drawings, in which:

FIG. 1 is an exemplary structural overview of a system for managing CAD knowledge in accordance with at least one embodiment of the present disclosure.

FIG. 2 is an exemplary overview of a CAD model utilizing a SysML knowledge model through the knowledge server in accordance with at least one embodiment of the present invention.

FIG. 3. is an exemplary flowchart for a process of managing CAD knowledge in accordance with at least one embodiment of the present invention.

### DETAILED DESCRIPTION

In the following description of the various examples, reference is made to the accompanying drawings which are illustrations of various embodiments in which the method may be practiced.

The present disclosure is directed to a method of managing CAD knowledge. The method may be embodied on a computer-readable storage medium which may be used on any suitable hardware platform such as a desktop computer, laptop computer, personal digital assistant (PDA) or similar device.

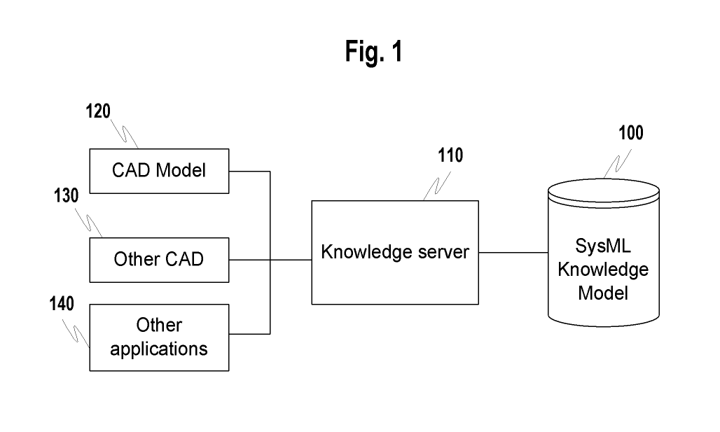

The system for managing CAD knowledge is described below in conjunction with the structural overview illustrated in FIG. 1.

In accordance with an exemplary embodiment, knowledge from a CAD model may be extracted from the CAD model and modeled using a modeling language such as SysML. Knowledge may include scientific principles, guidelines, rules, etc. For example, knowledge may include safety guidelines that may be modeled using a modeling language and made available to other applications. The resulting SysML knowledge model may then be stored in a knowledge repository 100. The knowledge repository 100 may be a hard disk drive, CD-ROM, DVD-ROM, or similar storage device. The knowledge repository 100 may be coupled to a knowledge server 110, which allows access to the knowledge stored in the knowledge repository 100 through a standard interface. This advantageously allows other applications to access the knowledge, and if there is a change in the SysML knowledge model, the results of the change are substantially immediately updated in the SysML model and in the CAD model and any other applications using the SysML knowledge model.

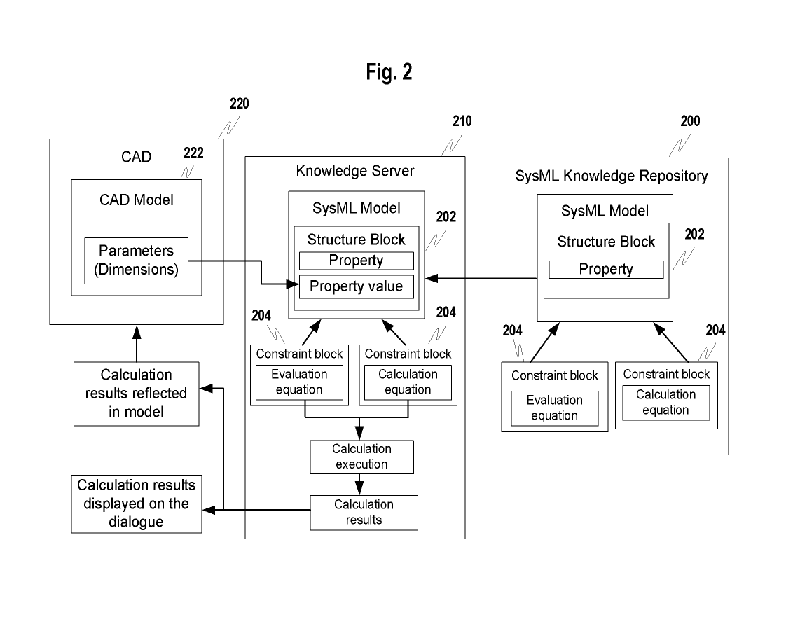

FIG. 2 discloses an exemplary overview of a CAD model utilizing a SysML knowledge model through the knowledge server in accordance with at least one embodiment. The knowledge repository 200 stores the SysML knowledge model 202, which may include, for example, evaluation and calculation equations as constraint blocks 204 in the knowledge model. CAD application 220 may access the SysML knowledge model by communicating with the knowledge server 210 as previously described. Knowledge server 210 may include services or applications for running SysML. Knowledge server 210 may receive, from CAD application 220, parameters such as dimensions from a CAD model 222, and instantiate the SysML knowledge model 202 using the parameters received from the CAD model 222. The parameters may be instantiated as property values in the SysML knowledge model 202 and applied to the evaluation and calculation equations in constraint blocks 204. The results of the calculations are substantially immediately reflected in the CAD model 222 and may be displayed on a dialogue of the CAD model 222.

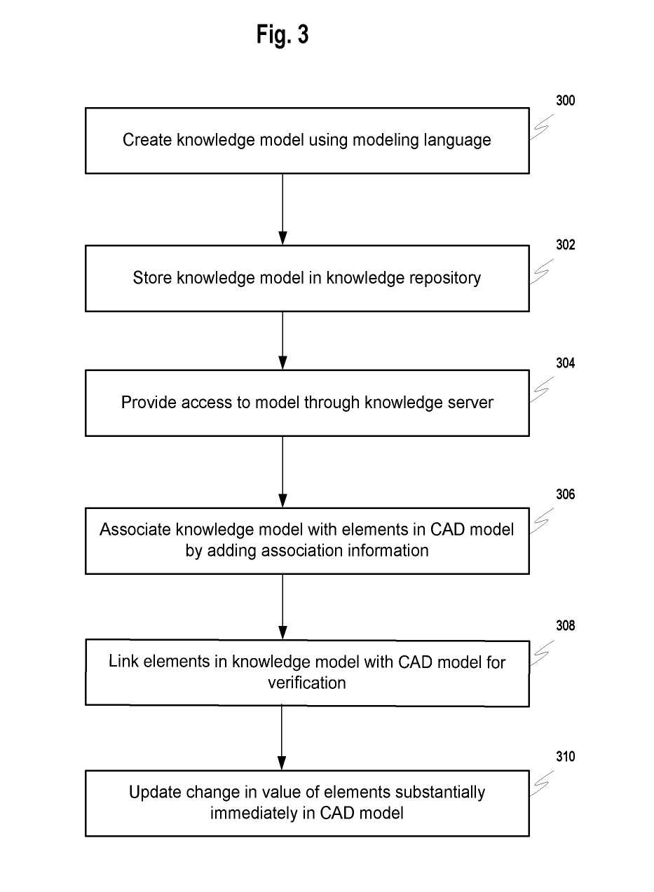

The method for managing CAD knowledge is described below in conjunction with the process illustrated in FIG. 3.

In accordance with an exemplary embodiment, knowledge from a CAD model may be extracted from the CAD model and modeled using a modeling language such as SysML (step 300). The SysML knowledge model may be stored in a knowledge repository (step 302) such as a hard disk drive, CD-ROM, DVD-ROM, etc. A knowledge server may allow a CAD model or other applications (e.g., Excel, web, etc.) to access to the SysML knowledge model through a standard interface such as for example, a web service based on SOAP (step 304). A CAD model or other application may access the SysML knowledge model by communicating with the knowledge server. Elements of the SysML knowledge model may be associated, through a dialogical user interface, with elements of the CAD model by adding association information to the elements in the CAD model (step 306). The association information, which denotes that “it is an interface for cooperation” may be added to the elements and the interface name may be used as a key (loose coupling). Alternatively, a unique ID may be issued by the system and the ID may be used a key (close coupling). Also, the name of an element may be used as a key (quasi-loose coupling). Association between one or more elements of the SysML knowledge model and one or more elements of the CAD model may be flexibly performed on various levels such as one-to-one, one-to-many, many-to-one and many-to-many.

Once elements between the CAD model and the SysML knowledge model are associated, one or more elements in the SysML knowledge model may be linked, as verification objects, to corresponding elements in the CAD model (step 308). The verification may be conducted through a dialogical user interface. Constraint blocks in the SysML knowledge model may be designated as verification objects of corresponding elements in the CAD model. In accordance with at least one embodiment, the SysML model may be deployed as a tree structure in the memory (not shown) of the knowledge server. When analyzing an equation defined as a constraint block in the SysML model, the tree structure may be searched starting with a structure block (e.g., an element of the CAD model) being a base point. The tree is traversed starting with the structure block until the parameters necessary for solving the equation are found. A constraint block may be instantiated for each structure block associated therewith.

Thus, in accordance with an exemplary embodiment, when values of parameters such as dimensions of elements in the SysML knowledge model are changed, the resulting changes in the CAD model are updated substantially immediately (step 310). For example, when dimensions of an object are changed in the SysML knowledge model, the changes will be applied to the CAD model substantially immediately. Additionally, the changes will be updated in not only the CAD model, but also in other applications using the SysML knowledge model. Arranging the SysML model on the knowledge server advantageously allows for not only static verification, but also for feedback-type dynamic verification. For example, parameters from a CAD model may be transmitted to the SysML model. The SysML model may then be used to calculate results, and the results may be transmitted to the CAD model for processing. The processed results may then be transmitted back to the SysML model where they may be re-calculated based on the processing performed by the CAD model.

It will be appreciated by persons skilled in the art that the present disclosure is not limited to what has been particularly shown and described hereinabove. Rather, the scope of the present disclosure is defined by the claims which follow. It should further be understood that the above description is only representative of illustrative examples of embodiments. For the reader's convenience, the above description has focused on a representative sample of possible embodiments, a sample that teaches the principles of the present disclosure. Other embodiments may result from a different combination of portions of different embodiments.

The description has not attempted to exhaustively enumerate all possible variations. The alternate embodiments may not have been presented for a specific portion of the disclosure, and may result from a different combination of described portions, or that other undescribed alternate embodiments may be available for a portion, is not to be considered a disclaimer of those alternate embodiments. Accordingly, the breadth and scope of the present disclosure should not be limited by any of the above-described exemplary embodiments, but should be defined only in accordance with the following claims and their equivalents.

1. A method for managing CAD knowledge, comprising:
creating a model of CAD knowledge using a modeling language;
storing the knowledge model in a knowledge repository;
providing access to the knowledge model through a knowledge server;
associating the knowledge model with elements of a CAD model by adding association information to the elements;
linking, as a verification object, one or more elements in the CAD model with one or more corresponding elements in the knowledge model; and
updating immediately, a change in value of the one or more elements in the knowledge model in both the CAD model and in the knowledge model.
